(19) United States
(12) Patent Application Publication
(10) Pub. No.: US 2026/0166564 A1
(43) Pub. Date: Jun. 18, 2026

(54) PYROLYSIS DEVICE FOR WASTE CIRCUIT BOARDS

(71) Applicants: BEIJING UNIVERSITY OF TECHNOLOGY, Beijing (CN); JIANGSU RUNLIAN RENEWABLE RESOURCES TECHNOLOGY CO., LTD., Changzhou (CN)

(72) Inventors: Yufeng WU, Beijing (CN); Xiaofei YIN, Changzhou (CN); Zhi LI, Changzhou (CN); Mengyu ZHAI, Beijing (CN); Jianghao DING, Changzhou (CN); Lu CAI, Changzhou (CN); Songliang HE, Changzhou (CN); Huaidong WANG, Changzhou (CN)

(73) Assignees: BEIJING UNIVERSITY OF TECHNOLOGY, Beijing (CN); JIANGSU RUNLIAN RENEWABLE RESOURCES TECHNOLOGY CO., LTD., Changzhou (CN)

(21) Appl. No.: 19/387,568

(22) Filed: Nov. 12, 2025

(30) Foreign Application Priority Data
Nov. 12, 2024 (CN) 202411605172.1

(51) Int. Cl. B03C 1/30; B03C 1/12; B09B 3/35; B09B 3/40; B09B 101/17; C09C 1/56; C10B 53/00

(52) U.S. Cl. CPC B03C 1/30; B03C 1/12; B09B 3/35; B09B 3/40; C09C 1/56; C10B 53/00; B03C 2201/20; B09B 2101/17

(57) ABSTRACT

The present disclosure relates to a technical field of waste circuit board processing. A pyrolysis device for a waste circuit board is provided, including a pyrolysis furnace for performing pyrolysis treatment on the waste circuit board; a carbon black collection tank for collecting carbon black formed after the pyrolysis treatment; a processing unit for crushing the carbon black and separating magnetic metal from the carbon black; and a helical conveyor. A feeding end of the helical conveyor is located in the carbon black collection tank, and a discharging end is connected to the processing unit. The processing unit includes a crushing assembly including a housing, two sorting tubes rotatably connected to the housing, a first guide plate disposed on the housing, two adjustment sections respectively provided in the two sorting tubes and connected to the housing, and a plurality of permanent magnets connected to each adjustment section.

### CROSS-REFERENCE TO RELATED APPLICATIONS

This application claims priority to Chinese Application No. 202411605172.1, filed on Nov. 12, 2024, the entire contents of which are hereby incorporated by reference.

### TECHNICAL FIELD

The present disclosure relates to a field of waste circuit board processing, and in particular, to a pyrolysis device for a waste circuit board.

### BACKGROUND

Pyrolysis technology primarily utilizes high temperature and high pressure conditions to pyrolyze plastic from a waste circuit board, decomposing it into low molecular weight compounds. Concurrently, this process facilitates thorough separation of metal and plastic through chemical treatment. This method can not only effectively recover metal and plastic resources from the waste circuit board, but also avoid secondary pollution associated with traditional treatment methods.

Existing magnetic separation devices mostly employ a plurality of magnets arranged on a sorting tube. The magnets are distributed in a semicircular pattern on an outer wall of the sorting tube. The magnets can attract falling a ferromagnetic material, causing it to adhere to the sorting tube. Then, as the sorting tube rotates, the ferromagnetic material moves to a non-magnetic region on the sorting tube. At this point, the ferromagnetic material falls into a designated collection region by gravity. Although a crushing device is provided in the carbon black collection tank, some ferromagnetic pieces may remain relatively large in mass even after the crushing process. When the mass of the ferromagnetic material is too large, the magnetic force generated by the magnets is insufficient to retain the ferromagnetic material in the intended location. The ferromagnetic material then falls into the collection region for non-magnetic materials under its own gravity, resulting in a lower actual recovery yield of ferromagnetic material than intended.

Therefore, the effective separation and collection of the ferromagnetic material remains a challenge to be addressed. In view of this, it is desirable to provide a pyrolysis device for a waste circuit board to solve the above problems existing in the prior art.

### SUMMARY

One or more embodiments of the present disclosure provide a pyrolysis device for a waste circuit board, including:
a pyrolysis furnace configured to perform pyrolysis treatment on the waste circuit board;
a carbon black collection tank configured to collect carbon black formed after the pyrolysis treatment of the circuit board;
a processing unit configured to crush the carbon black and separate magnetic metal from the carbon black;
a helical conveyor, wherein a feeding end of the helical conveyor is located in the carbon black collection tank, a discharging end of the helical conveyor is connected to the processing unit, and the helical conveyor is configured to transfer the carbon black to the processing unit;
wherein the processing unit includes a crushing assembly, and the crushing assembly includes a housing, two sorting tubes rotatably connected to the housing, a first guide plate disposed on the housing, two adjustment sections respectively provided in the two sorting tubes and connected to the housing, and a plurality of permanent magnets connected to each of the two adjustment sections;
each of the two adjustment sections is configured to adjust a distance between each of the plurality of permanent magnets and an inner wall of a corresponding sorting tube in the two sorting tubes, so that the plurality of permanent magnets attract the magnetic metal in the carbon black;
each of the two adjustment sections includes a connection shaft disposed on the housing, a first connecting sleeve and a second connecting sleeve sleeved on the connection shaft, and a driving member disposed on the second connecting sleeve;
the driving member includes a plurality of mounting seats disposed on the second connecting sleeve, a plurality of adjustment shafts disposed on the plurality of mounting seats, respectively, a plurality of adjustment gears sleeved on the plurality of adjustment shafts, respectively, universal joints for connecting adjacent adjustment shafts, and a plurality of adjustment racks meshing with the plurality of adjustment gears, respectively;
one of the universal joints is replaceable with a driving motor;
both the first connecting sleeve and the second connecting sleeve are provided with a plurality of grooves configured to place the plurality of adjustment racks, respectively, an inner wall of each of the plurality of grooves is provided with a limiting groove, and a protrusion adapted to the limiting groove is provided along a length direction of each of the plurality of adjustment racks;
the two sorting tubes are divided into a first sorting tube and a second sorting tube according to a moving sequence of the carbon black in the processing unit, wherein a rotation direction of the first sorting tube is opposite to a rotation direction of the second sorting tube, and the first sorting tube rotates in a counterclockwise direction;
the housing is further provided with a second guide plate and a third guide plate, and a first preset distance exists between each of the second guide plate and the third guide plate and an outer wall of the second sorting tube;
in an orthographic projection direction, a second preset distance exists between an axis of the first sorting tube and an axis of the second sorting tube, so that the carbon black sorted by the first sorting tube falls onto the second sorting tube;
a distance between each of a plurality of permanent magnets in an adjustment section located in the first sorting tube and an inner wall of the first sorting tube is greater than a distance between each of a plurality of permanent magnets in an adjustment section located in the second sorting tube and an inner wall of the second sorting tube; each adjustment section further includes a plurality of connecting rods for connecting the first connecting sleeve and the second connecting sleeve;
the plurality of connecting rods sequentially connect the plurality of permanent magnets located on a corresponding sorting tube to form a C-shaped structure, a diameter of the C-shaped structure is greater than an outer diameter of the second connecting sleeve and less than an inner diameter of the corresponding sorting tube;
the driving member is connected to the plurality of permanent magnets, configured to change locations of the plurality of permanent magnets in the corresponding sorting tube and enable the plurality of permanent magnets to perform synchronous movement, so as to adjust the distance between each of the plurality of permanent magnets and the inner wall of the corresponding sorting tube; and
the distance between each of the plurality of permanent magnets located in the first sorting tube and the inner wall of the first sorting tube is different from the distance between each of the plurality of permanent magnets in the adjustment section located in the second sorting tube and the inner wall of the second sorting tube.

### BRIEF DESCRIPTION OF THE DRAWINGS

The present disclosure will be further explained by way of exemplary embodiments. These exemplary embodiments will be described in detail through the accompanying drawings. These embodiments are not limiting. In these embodiments, the same reference numerals denote the same structures, wherein:

FIG. 1 is a schematic diagram of a pyrolysis device for a waste circuit board according to some embodiments of the present disclosure;

FIG. 2 is a schematic structural diagram of a crushing assembly according to some embodiments of the present disclosure;

FIG. 3 is a schematic structural diagram of an adjustment section according to some embodiments of the present disclosure;

FIG. 4 is a schematic diagram of a permanent magnet according to some embodiments of the present disclosure;

FIG. 5 is a schematic structural diagram of a crushing section according to some embodiments of the present disclosure;

FIG. 6 is a schematic diagram of a cooling assembly according to some embodiments of the present disclosure;

FIG. 7 is a perspective view of a transfer assembly according to some embodiments of the present disclosure;

FIG. 8 is a schematic structural diagram of an adjustment mechanism according to some embodiments of the present disclosure;

FIG. 9 is another schematic diagram of the pyrolysis device for the waste circuit board according to some embodiments of the present disclosure;

FIG. 10 is a flowchart of a process for controlling an operation of an adjustment section according to some embodiments of the present disclosure; and

FIG. 11 is a schematic diagram of a purity prediction model according to some embodiments of the present disclosure.

Reference numerals: 1, pyrolysis furnace; 2, carbon black collection tank; 3, helical conveyor; 4, cooling assembly; 41, cooling box; 42, water inlet pipe; 43, hopper; 44, feeding motor; 45, feeding pipe; 451, carbon black distribution plate; 46, helical mandrel; 47, helical blade; 48, first partition plate; 49, second partition plate; 410, first connecting pipe; 411, second connecting pipe; 412, communication pipe; 413, water outlet pipe; 5, transfer assembly; 51, mounting frame; 52, adjustment mechanism; 521, adjustment motor; 522, sliding rail; 523, transmission block; 524, driving gear; 525, driven gear; 526, transmission screw rod; 527, moving frame; 528, slider; 53, connecting frame; 54, inclined plate; 6, crushing assembly; 61, housing; 62, adjustment section; 621, connection shaft; 622, first connecting sleeve; 623, connecting rod; 624, second connecting sleeve; 625, mounting seat; 626, adjustment shaft; 627, universal joint; 628, adjustment gear; 629, driving motor; 6210, adjustment rack; 63, first guide plate; 64, second guide plate; 65, third guide plate; 66, crushing section; 661, crushing motor; 662, transmission belt; 663, driven wheel; 664, first crushing plate; 665, second crushing plate; 666, first connecting rod; 667, second connecting rod; 668, rotating shaft; 669, fixed seat; 67, permanent magnet; 68, sorting tube; 7, support frame; 81, processor; 82, imaging unit; 83, vibration unit; 84, acoustic sensing unit; 85, airflow blowing unit.

### DETAILED DESCRIPTION

To make the above objectives, features, and advantages of the present disclosure more apparent and easier to understand, the specific implementations of the present disclosure are described in detail below with reference to the accompanying drawings.

Many specific details are set forth in the following description to facilitate full understanding of the present disclosure. However, the present disclosure can also be implemented in other ways different from those described herein. Those skilled in the art can make similar extensions without departing from the spirit of the present disclosure. Therefore, the present disclosure is not limited by the specific embodiments disclosed below.

Secondly, the term “an embodiment” or “one embodiment” mentioned herein refers to a specific feature, structure, or characteristic that can be included in at least one implementation of the present disclosure. The appearances of the phrase “in an embodiment” in various portions in the present disclosure are not necessarily all referring to the same embodiment, nor are separate or alternative embodiments mutually exclusive of other embodiments.

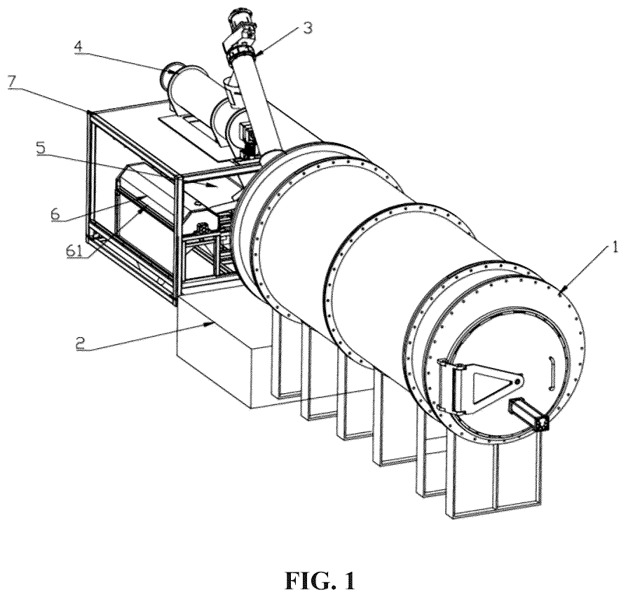

FIG. 1 is a schematic diagram of a pyrolysis device for a waste circuit board according to some embodiments of the present disclosure.

The present disclosure discloses a pyrolysis device for a waste circuit board (hereinafter referred to as “the pyrolysis device”). Referring to FIG. 1, the pyrolysis device includes: a pyrolysis furnace 1 configured to perform pyrolysis treatment on a waste circuit board; a carbon black collection tank 2 configured to collect carbon black formed after pyrolysis treatment of the waste circuit board; a processing unit configured to crush the carbon black and separate magnetic metal from the carbon black; and a helical conveyor 3. A feeding end of the helical conveyor 3 is located in the carbon black collection tank 2, and a discharging end of the helical conveyor 3 is connected to the processing unit. The helical conveyor 3 is configured to transfer the carbon black to the processing unit.

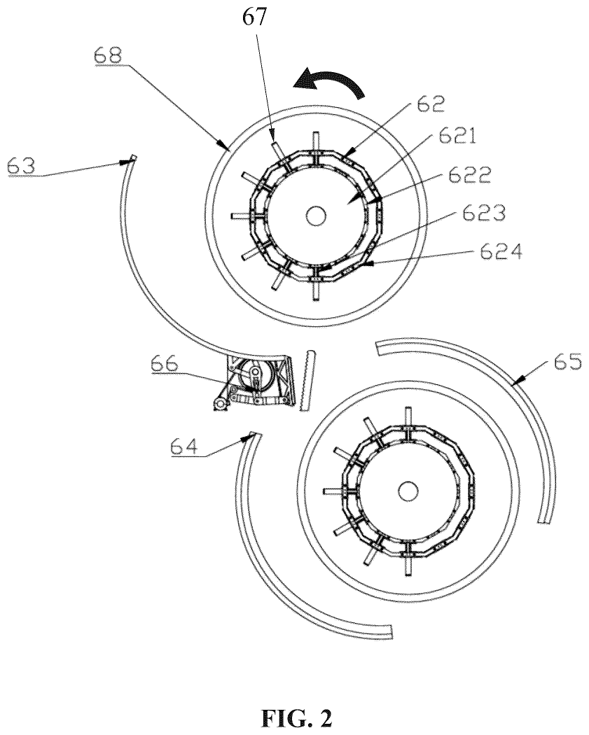

FIG. 2 is a schematic structural diagram of a crushing assembly according to some embodiments of the present disclosure.

In some embodiments, the processing unit includes a crushing assembly 6. The crushing assembly 6 refers to an assembly configured to crush the carbon black. In some embodiments, the crushing assembly 6 includes a housing 61, two sorting tubes 68 rotatably connected to the housing 61, a first guide plate 63 disposed on the housing 61, two adjustment sections 62 respectively provided in the two sorting tubes 68 and connected to the housing 61, and a plurality of permanent magnets 67 connected to each of the two adjustment sections 62. The first guide plate 63 refers to a plate member configured to guide a ferromagnetic material attached with the carbon black to a crushing section 66.

Each of the two adjustment sections 62 is configured to adjust a distance between each of the plurality of permanent magnets 67 and an inner wall of a corresponding sorting tube 68, so that the plurality of permanent magnets 67 attract the magnetic metal in the carbon black.

In some embodiments, each of the two adjustment sections 62 includes a connection shaft 621 disposed on the housing 61, a first connecting sleeve 622 and a second connecting sleeve 624 sleeved on the connection shaft 621, a plurality of connecting rods 623 configured to connect the first connecting sleeve 622 and the second connecting sleeve 624, and a driving member disposed on the second connecting sleeve 624. The plurality of connecting rods 623 sequentially connect the plurality of permanent magnets 67 located on the corresponding sorting tube 68 to form a C-shaped structure. An outer diameter of the C-shaped structure is greater than an outer diameter of the second connecting sleeve 624 and less than an inner diameter of the corresponding sorting tube 68.

In some embodiments, the driving member is connected to the plurality of permanent magnets 67 and is configured to change locations of the plurality of permanent magnets 67 in the corresponding sorting tube 68, enable the plurality of permanent magnets 67 to perform synchronous movement, so as to adjust the distance between each of the plurality of permanent magnets 67 and the inner wall of the corresponding sorting tube 68. Distances between the plurality of permanent magnets 67 located in the two sorting tubes 68 and the inner walls of the corresponding sorting tubes 68 are different. By arranging the plurality of permanent magnets 67, a magnetic attraction region and a non-magnetic attraction region can be formed on the sorting tubes 68. By rotating the sorting tube 68, the ferromagnetic material attached to the sorting tubes 68 can move from the magnetic attraction region to the non-magnetic attraction region. Then, the ferromagnetic material can fall into a designated collection region under its own gravity, thereby completing the collection of the ferromagnetic material.

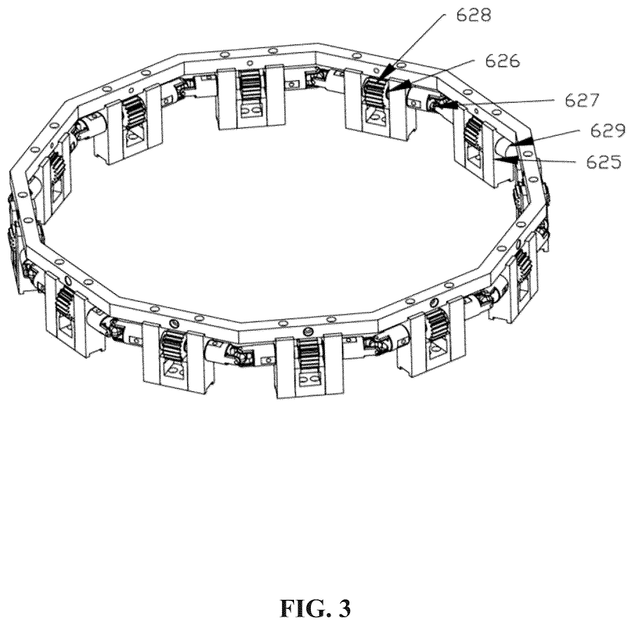

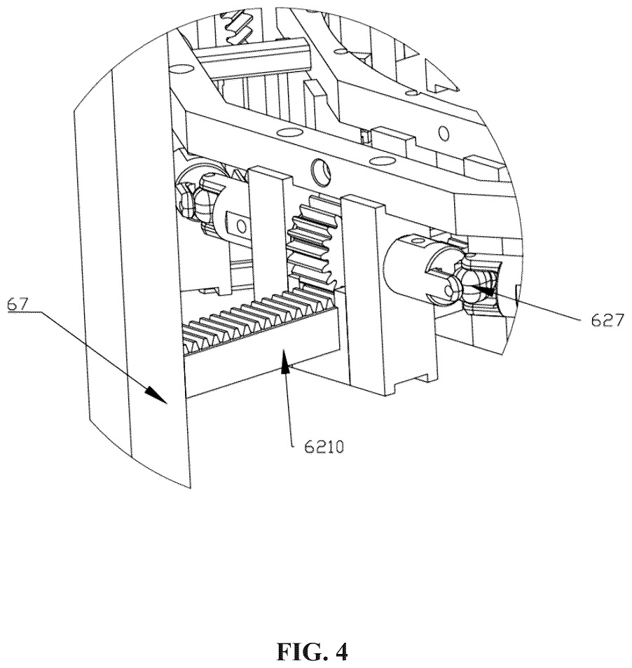

FIG. 3 is a schematic structural diagram of an adjustment section according to some embodiments of the present disclosure. FIG. 4 is a schematic diagram of a permanent magnet according to some embodiments of the present disclosure.

In some embodiments, the driving member includes a plurality of mounting seats 625 disposed on the second connecting sleeve 624, a plurality of adjustment shafts 626 disposed on the plurality of mounting seats 625, respectively, a plurality of adjustment gears 628 sleeved on the plurality of adjustment shafts 626, respectively, universal joints 627 for connecting adjacent adjustment shafts 626, and a plurality of adjustment racks 6210 meshing with the plurality of adjustment gears 628, respectively. The adjustment rack 6210 refers to a component configured to drive the permanent magnet 67 to move. In some embodiments, one end of the adjustment rack 6210 is fixedly connected to one permanent magnet 67.

In some embodiments, one of the universal joints 627 is replaceable with a driving motor 629. The driving motor 629 refers to a motor configured to provide rotation for the adjustment shafts 626.

Both the first connecting sleeve 622 and the second connecting sleeve 624 are provided with a plurality of grooves for placing the plurality of adjustment racks 6210. An inner wall of the each of the plurality of grooves is provided with a limiting groove. A protrusion adapted to the limiting groove is provided along a length direction of each of the plurality of adjustment racks 6210. The mounting seat 625 has a U-shaped structure. The limiting groove is configured to cooperate with the protrusion of the adjustment rack 6210 to achieve limiting of the adjustment rack 6210 in a direction perpendicular to its length direction.

When it is necessary to adjust the location of the permanent magnets 67, the driving motor 629 starts to operate. The operating driving motor 629 may drive the connected adjustment shaft 626 to rotate. The rotating adjustment shaft 626 may drive the connected universal joint 627 to rotate, thereby driving another adjustment shaft 626 to rotate. The rotating adjustment shaft 626 may drive the adjustment gear 628 to rotate, thereby driving the adjustment rack 6210 to move, so that the plurality of permanent magnets 67 may extend or retract synchronously, making the shortest distance between each of the plurality of permanent magnets 67 and the inner wall of the corresponding sorting tube 68 the same, thereby enabling the attraction of the ferromagnetic material. Meanwhile, by adjusting the distance between the permanent magnet 67 and the inner wall of the corresponding sorting tube 68, the magnetic force of the permanent magnet 67 on the ferromagnetic material is changed, so that the ferromagnetic material can be attracted on the two sorting tubes 68.

The sorting tube 68 refers to a tube configured to screen the magnetic metal in the carbon black. In some embodiments, the two sorting tubes 68 are divided into a first sorting tube and a second sorting tube according to a movement sequence of the carbon black in the processing unit. That is, the sorting tube that the carbon black passes through first is the first sorting tube, and the sorting tube that the carbon black passes through later is the second sorting tube. A rotation direction of the first sorting tube is opposite to a rotation direction of the second sorting tube. For example, as shown in FIG. 2, the first sorting tube rotates in a counterclockwise direction.

In some embodiments, the housing 61 is further provided with a second guide plate 64 and a third guide plate 65. A first preset distance exists between the second guide plate 64 and an outer wall of the second sorting tube and between the third guide plate 65 and the outer wall of the second sorting tube. The second guide plate 64 refers to a plate member configured to guide the separated non-magnetic metal and inherent impurities. The third guide plate 65 refers to a plate member configured to guide the separated magnetic metal.

In some embodiments, a second preset distance exists between axes of the first sorting tube and the second sorting tube in an orthographic projection direction, so that the carbon black separated by the first sorting tube may fall onto the second sorting tube. A distance between each of the plurality of permanent magnets 67 in the adjustment section 62 located in the first sorting tube and the inner wall of the first sorting tube 68 is greater than a distance between each of the plurality of permanent magnets 67 in the adjustment section 62 located in the second sorting tube and the inner wall of the second sorting tube 68. A channel formed between the second guide plate 64 and the outer wall of the second sorting tube is configured to pass the non-magnetic metal and the inherent impurities. A channel formed between the outer wall of the second sorting tube and a side of the third guide plate 65 facing the second sorting tube is configured to pass magnetic metal exceeding a preset mass and provide a certain limiting function to avoid damage to the housing 61 caused by an excessive centrifugal force of the magnetic metal. A channel formed between a side of the third guide plate 65 away from the outer wall of the second sorting tube and the housing 61 is configured to pass the magnetic metal of the preset mass. An output side of the third guide plate 65 may also be provided with a partition plate, which may separate the magnetic metal exceeding the preset mass and the magnetic metal of the preset mass.

By providing the adjustment section 62, the locations of the plurality of permanent magnets 67 in the second sorting tube can be adjusted, so that the second sorting tube can perform an attraction operation on the ferromagnetic material with a larger mass. By increasing the distance between the permanent magnet 67 in the second sorting tube and the inner wall of the sorting tube 68, and by allowing the carbon black to fall directly onto the second sorting tube, it is possible to avoid a situation where a distance between the ferromagnetic material and the second sorting tube is too large or a magnetic force of the permanent magnet 67 is too small, which could lead to a failure of its attraction operation. This enables the attraction operation on ferromagnetic members exceeding a predetermined mass to be completed.

The pyrolysis device described above can perform the attraction operation on the ferromagnetic material with a relatively large mass. However, during the pyrolysis treatment of the waste circuit board, a large amount of carbon black is generated, and the carbon black may encapsulate the ferromagnetic material. Although a crushing device provided in the carbon black collection tank 2 can perform a preliminary crushing operation on the carbon black, there will still be particles with a relatively large diameter transferred to the crushing assembly 6. Firstly, the magnetic force of the permanent magnets 67 on the ferromagnetic material encapsulated by the carbon black will decrease. Secondly, the mass of the ferromagnetic material attached with carbon black will increase, making it difficult for the permanent magnets 67 located in the first sorting tube to attract such ferromagnetic material. Consequently, this type of ferromagnetic material falls into a region where impurities are located, resulting in a waste of resources.

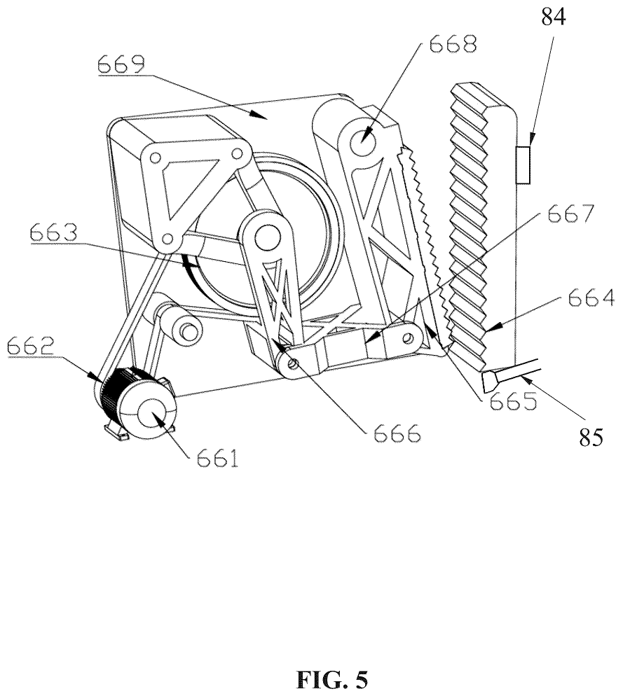

FIG. 5 is a schematic structural diagram of a crushing section according to some embodiments of the present disclosure.

To solve the above problem, in some embodiments, as shown in FIG. 2, the processing unit further includes a crushing section 66. The crushing section 66 refers to a portion for pulverizing the carbon black separated out by the first sorting tube.

In some embodiments, as shown in FIG. 5, the crushing section 66 includes a first crushing plate 664 and a plurality of fixed seats 669 disposed in the housing 61, a plurality of crushing members disposed on the plurality of fixed seats 669, respectively, a driving shaft for connecting the plurality of crushing members, and a driving mechanism connected to one of the crushing members.

In some embodiments, each crushing member includes a driven wheel 663 rotatably connected to a corresponding fixed seat 669, a first connecting rod 666 connected to the driven wheel 663, a second connecting rod 667 movably connected to the first connecting rod 666, and a second crushing plate 665 movably connected to the second connecting rod 667. The second crushing plate 665 is movably connected to the fixed seat 669 via a rotating shaft 668.

In some embodiments, the driving mechanism includes a crushing motor 661 connected to the housing 61, a driving wheel provided at an output end of the crushing motor 661, and a transmission belt 662 for connecting the driving wheel and the driven wheel 663. A region between the first crushing plate 664 and the second crushing plate 665 is a crushing region for the carbon black.

The crushing motor 661 refers to a motor for driving the second crushing plate 665 to crush the carbon black. In some embodiments, the crushing motor 661 may drive the second crushing plate 665 to perform a reciprocating motion, thereby crushing the carbon black located in the crushing region, and performing an attraction operation thereon via the plurality of permanent magnets 67.

The driven wheel 663 refers to a component for transmitting a driving force transmitted from the driving wheel to other crushing members. The driven wheel 663 is sleeved on the driving shaft.

The ferromagnetic material attached with carbon black falls from the discharging end of the first guide plate 63 into the crushing section 66 due to gravity. Then, the crushing motor 661 starts to operate. The operating crushing motor 661 may drive the driving wheel to rotate. The provided transmission belt 662 may drive the driven wheel 663 to rotate. The operating driven wheel 663 may drive the driving shaft to move, thereby driving the driven wheels 663 in other crushing members to rotate. The operating driven wheel 663 may drive the first connecting rod 666 to move. The moving first connecting rod 666 may drive the second connecting rod 667 to move. Then, the moving second connecting rod 667 may cause the second crushing plate 665 to rotate about the rotating shaft 668, thereby crushing the carbon black passing between the first crushing plate 664 and the second crushing plate 665. This enables the pulverization of the carbon black encapsulating the ferromagnetic material, reducing the mass of the carbon black, so that the permanent magnets 67 can attract the ferromagnetic material. Then, as the sorting tube 68 rotates, the ferromagnetic material may be sorted.

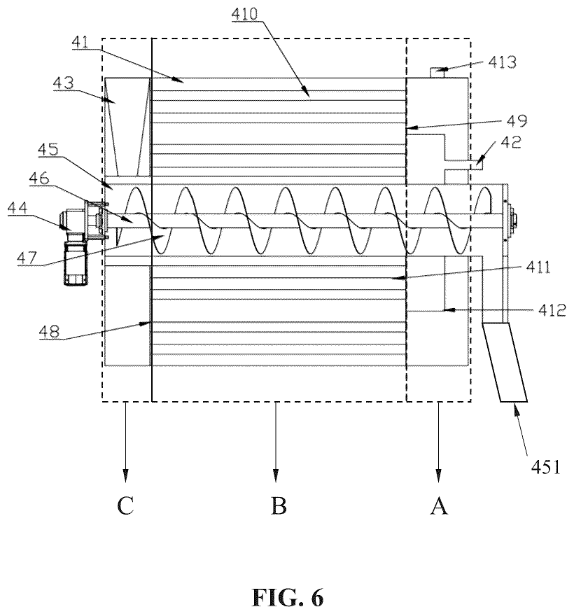

FIG. 6 is a schematic diagram of a cooling assembly according to some embodiments of the present disclosure.

In some embodiments, as shown in FIGS. 1 and 6, the processing unit further includes a support frame 7, a cooling assembly 4 disposed on the support frame 7 and connected to the helical conveyor 3, a transfer assembly 5 connected to a discharging end of the cooling assembly 4, and at least two hoppers 43 connected to the crushing assembly 6. The transfer assembly 5 is configured to transfer the carbon black to the crushing assembly 6. The support frame 7 refers to a frame structure for carrying or accommodating the cooling assembly 4, the transfer assembly 5, and the crushing assembly 6. The cooling assembly 4 refers to an assembly for cooling the carbon black. The transfer assembly 5 refers to an assembly for transferring the cooled carbon black to the crushing assembly 6.

In some embodiments, the cooling assembly 4 includes a cooling box 41 fixedly disposed on the support frame 7, a feeding pipe 45 provided in the cooling box 41, a helical mandrel 46 located in the feeding pipe 45, a helical blade 47 disposed on the helical mandrel 46, a feeding motor 44 connected to one end of the helical mandrel 46 and located outside a shell of the cooling box 41, and the at least two hoppers 43 provided in the cooling box 41. The feeding pipe 45 refers to a pipe for transferring the carbon black from the hoppers 43 to the carbon black distribution plate 451. The helical mandrel 46 is configured to drive the helical blade 47 to uniformly transfer the carbon black within the feeding pipe 45. The feeding motor 44 refers to a motor for providing a driving force to the helical mandrel. The hopper 43 refers to a tank for temporarily storing and cooling the preliminarily crushed carbon black.

In some embodiments, one end of the at least two hoppers 43 is connected to the discharging end of the helical conveyor 3, and the other end is in communication with the feeding pipe 45. In some embodiments, a carbon black distribution plate 451 is provided at the discharging end of the feeding pipe 45.

After the pyrolysis treatment is completed, the waste circuit board after the pyrolysis treatment generates carbon black. By rotating the pyrolysis furnace 1, the carbon black may fall from the discharging end of the pyrolysis furnace 1 into the carbon black collection tank 2. Then, the crushing device provided in the carbon black collection tank 2 performs a preliminary crushing operation on the carbon black. Then, the helical conveyor 3 starts to operate, causing the carbon black to move from the carbon black collection tank 2 into the hopper 43 and fall into the feeding pipe 45. Then, the feeding motor 44 starts to operate. The operating feeding motor 44 may drive the connected helical mandrel 46 to start rotating. Then, the operating helical mandrel 46 may drive the helical blade 47 to move, transferring the carbon black along a length direction of the feeding pipe 45, so that the carbon black may fall onto the carbon black distribution plate 451. Then, the carbon black falls onto the inclined plate 54 via the carbon black distribution plate 451. According to the coordinated operation of the provided helical mandrel 46 and helical blade 47, the transmission of the carbon black can be completed, allowing the carbon black to be transferred to the transfer assembly 5.

When the waste circuit board is in the pyrolysis furnace 1, the waste circuit board is placed in an oxygen-deficient or oxygen-free state and the pyrolysis furnace 1 is heated, thereby forming the carbon black. During the heating process, the temperature of the carbon black becomes excessively high. Consequently, during its crushing or processing, the high-temperature carbon black may splash, scalding operating personnel.

To solve the above problem, in some embodiments, as shown in FIG. 6, the cooling box 41 is provided with a first partition plate 48, a second partition plate 49, a water inlet pipe 42, and a water outlet pipe 413. According to a flow direction of a coolant in the cooling box 41, the first partition plate 48 and the second partition plate 49 divide the cooling box 41 into a first cooling zone A, a second cooling zone B, and a third cooling zone C.

In some embodiments, the cooling box 41 further includes a first connecting pipe 410 and a second connecting pipe 411 disposed in the second cooling zone B for communicating the first cooling zone A and the third cooling zone C, and a communication pipe 412 disposed on the second partition plate 49 and located in the first cooling zone A. A distance between the first connecting pipe 410 and the feeding pipe 45 is greater than a distance between the second connecting pipe 411 and the feeding pipe 45. A water inlet end of the second connecting pipe 411 is located in an overlapping region of the communication pipe 412 and the second partition plate 49. The at least two hoppers 43 are located in the third cooling zone C. The communication pipe 412 is in communication with the water inlet pipe 42. The water outlet pipe 413 is in communication with the first cooling zone A.

The water outlet pipe 413 is located at a top of the cooling box 41. The water inlet pipe 42 is located between the feeding pipe 45 and the water outlet pipe 413. Consequently, by supplying the coolant into the water inlet pipe 42, the coolant can be poured onto the feeding pipe 45.

Before using the helical conveyor 3 to transfer the carbon black to the feeding pipe 45, the coolant is injected into the communication pipe 412 via the water inlet pipe 42. At this time, the coolant may contact the feeding pipe 45, and then flow to the third cooling zone via the second connecting pipe 411. Then, as the coolant continues to be injected, a liquid level of the coolant in a region enclosed by the third cooling zone C, the cooling box 41, the communication pipe 412, and the second partition plate 49 rises. By allowing the coolant to flow in the first cooling zone A, the second cooling zone B, and the third cooling zone C, and simultaneously placing the hoppers 43 in the cooling box 41, the carbon black may be cooled, thereby reducing the temperature of the carbon black and avoiding scalding of the operating personnel by the high-temperature carbon black.

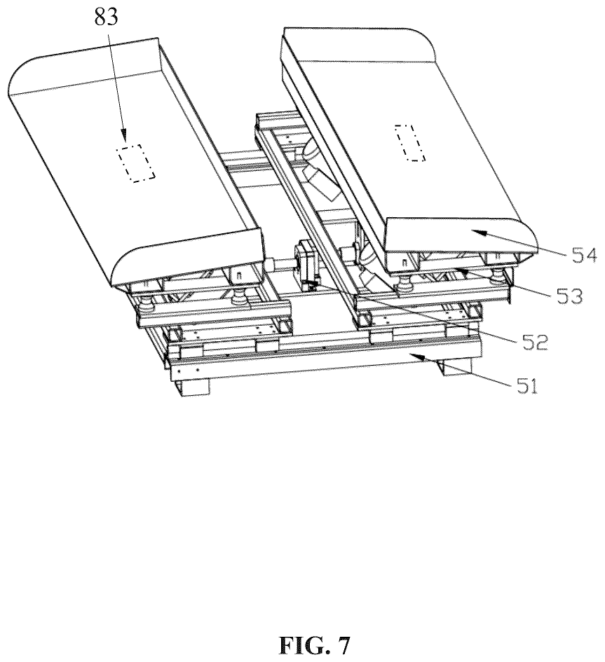

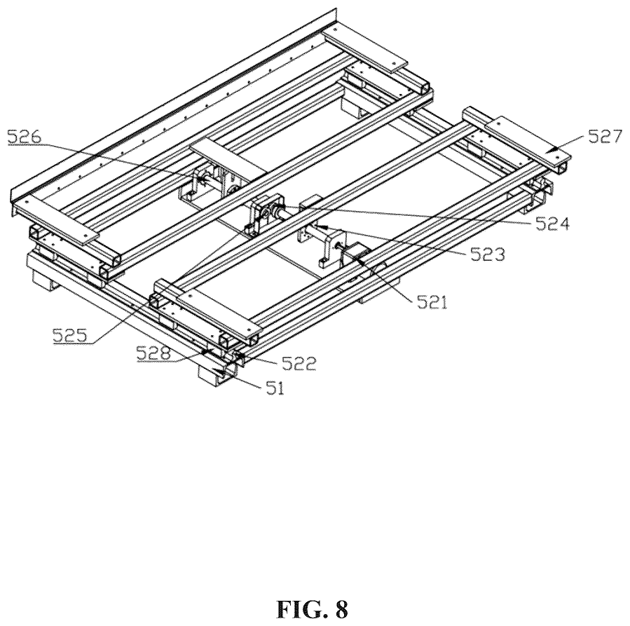

FIG. 7 is a perspective view of a transfer assembly according to some embodiments of the present disclosure. FIG. 8 is a schematic structural diagram of an adjustment mechanism according to some embodiments of the present disclosure.

In some embodiments, as shown in FIGS. 7-8, the transfer assembly 5 includes a mounting frame 51 disposed on the support frame 7, an adjustment mechanism 52 disposed on the mounting frame 51, a connecting frame 53 connected to the adjustment mechanism 52, and an inclined plate 54 disposed on the connecting frame 53 and forming a preset angle with a height direction of the connecting frame 53. The inclined plate 54 is configured to receive the carbon black falling from the carbon black distribution plate 451.

The adjustment mechanism 52 refers to a mechanism configured to adjust a location of the inclined plate 54. In some embodiments, the adjustment mechanism 52 includes a transmission member disposed on the mounting frame 51, two transmission blocks 523 connected to the transmission member, a moving frame 527 connected to the two transmission blocks 523, a slider 528 disposed on the moving frame 527, and a sliding rail 522 disposed on the mounting frame 51 and slidably connected to the slider 528. In some embodiments, the connecting frame 53 is connected to the moving frame 527.

In some embodiments, as shown in FIG. 8, the transmission member includes three supporting seats disposed on the mounting frame 51, two transmission screw rods 526 configured to connect adjacent supporting seats, and an adjustment motor 521 disposed on the mounting frame 51 and connected to one of the two transmission screw rods 526. Adjacent ends of the two transmission screw rods 526 are respectively provided with a driving gear 524 and a driven gear 525, and the driving gear 524 meshes with the driven gear 525. In some embodiments, the two transmission blocks 523 are respectively sleeved on the two transmission screw rods 526. The adjustment motor 521 refers to a motor configured to provide a driving force for adjusting the inclined plate 54. The transmission block 523 is configured to convert rotation of the transmission screw rod 526 into translation along a length direction of the transmission screw rod 526.

Before the pyrolysis treatment of the waste circuit board, the adjustment motor 521 starts to operate. The operating adjustment motor 521 drives the connected transmission screw rod 526 to rotate. Then, via the meshed driving gear 524 and driven gear 525, another transmission screw rod 526 is driven to rotate. The operating transmission screw rod 526 drives the transmission block 523 to move, thereby adjusting the location of the transmission block 523 along the length direction of the transmission screw rod 526, further adjusting the location of the moving frame 527 on the mounting frame 51, and thus adjusting the location of the inclined plate 54, so that the carbon black may fall from the carbon black distribution plate 451 onto the inclined plate 54, ensuring smooth transfer of the carbon black.

In some embodiments, the pyrolysis device further includes a first rotation mechanism and a second rotation mechanism. By providing the first rotation mechanism, the sorting tubes 68 can be driven to rotate. Simultaneously, in cooperation with the permanent magnets 67, the ferromagnetic material can be attracted onto the sorting tube 68. As the first rotation mechanism rotates, the ferromagnetic material is driven to rotate, moving the ferromagnetic material from a magnetic attraction region to a non-magnetic attraction region. Under the influence of its own gravity, the ferromagnetic material falls into a designated location. During this process, the screening of the ferromagnetic material is completed. However, when the mass of the ferromagnetic material is too small, although the ferromagnetic material is located in the non-magnetic attraction region, the magnetic force provided by the permanent magnets 67 in the magnetic attraction region is greater than its own gravity, causing it to adhere to the sorting tube 68. At this time, by operating the driving motor 629, the distance between the permanent magnet 67 and the inner wall of the sorting tube 68 can be adjusted, moving the permanent magnet 67 away from the ferromagnetic material to reduce the magnetic force of the permanent magnet 67 on the ferromagnetic material, allowing the ferromagnetic material to fall into the designated collection region, thereby completing the collection of the ferromagnetic material.

By providing the first rotation mechanism, the second sorting tube is driven to rotate, carrying the ferromagnetic material to rotate, thereby enabling it to be transferred to the designated location through the channel between the second sorting tube and the third guide plate 65.

Working principle description: Before the pyrolysis treatment of the waste circuit board, the locations of the plurality of permanent magnets 67 need to be adjusted. At this time, the driving motor 629 starts to operate. The operating driving motor 629 drives the connected adjustment shaft 626 to rotate. The operating adjustment shaft 626 drives the connected universal joint 627 to rotate, thereby driving another adjustment shaft 626 to rotate. The rotating adjustment shaft 626 drives the adjustment gear 628 to rotate, thereby driving the adjustment rack 6210 to move, enabling the plurality of permanent magnets 67 to extend or retract synchronously, so that the shortest distance between each of the plurality of permanent magnets 67 and the inner wall of the corresponding sorting tube 68 is the same, allowing the plurality of permanent magnets 67 to perform the attraction operation on the ferromagnetic material. Simultaneously, by adjusting the distance between each of the plurality of permanent magnets 67 and the inner wall of the corresponding sorting tube 68, the magnetic force of the permanent magnet 67 on the ferromagnetic material can be changed, thereby enabling the ferromagnetic material to be attracted onto the two sorting tubes 68. Simultaneously, before the pyrolysis treatment, the adjustment motor 521 also needs to be operated. The operating adjustment motor 521 drives the connected transmission screw rod 526 to rotate. Then, through the meshed driving gear 524 and driven gear 525, another transmission screw rod 526 is driven to rotate. The operating transmission screw rod 526 drives the transmission block 523 to move, adjusting the location of the transmission block 523 along the length direction of the transmission screw rod 526, further adjusting the location of the moving frame 527 on the mounting frame 51, and thus adjusting the location of the inclined plate 54, so that the carbon black can fall from the carbon black distribution plate 451 onto the inclined plate 54, ensuring smooth transfer of the carbon black. Before transferring the carbon black to the feeding pipe 45 using the helical conveyor 3, the coolant is injected into the communication pipe 412 through the water inlet pipe 42. At this time, the coolant can contact the feeding pipe 45, then flow along the second connecting pipe 411 to the third cooling zone C. As the coolant continues to be injected, the liquid level of the coolant in the region enclosed by the third cooling zone C, the cooling box 41, the communication pipe 412, and the second partition plate 49 rises. By allowing the coolant to flow in the first cooling zone A, the second cooling zone B, and the third cooling zone C, and simultaneously placing the hoppers 43 within the cooling box 41, the carbon black can be cooled, thereby reducing the temperature of the carbon black. Then, the operator can fill the waste circuit board into the pyrolysis furnace 1, create an oxygen-free environment for the circuit board in the pyrolysis furnace 1, and heat the pyrolysis furnace 1. The carbon black generated from the pyrolyzed circuit board is collected by the carbon black collection tank 2. Then, the carbon black is crushed by the crushing device disposed in the carbon black collection tank 2, and the carbon black is conveyed to the cooling assembly 4 by the helical conveyor 3. When the carbon black falls into the feeding pipe 45 through the hoppers 43, the feeding motor 44 starts to operate. The operating feeding motor 44 drives the connected helical mandrel 46 to start rotating. The operating helical mandrel 46 drives the helical blade 47 to operate, moving the carbon black along the length direction of the feeding pipe 45, allowing the carbon black to fall onto the carbon black distribution plate 451. Then, the carbon black falls onto the inclined plate 54 through the carbon black distribution plate 451. Through the cooperative operation of the helical mandrel 46 and the helical blade 47, the transfer of the carbon black is completed, enabling it to be transferred to the transfer assembly 5. Then, through the inclined plate 54 in the transfer assembly 5, the carbon black can be transferred into the housing 61. The permanent magnet 67 enables the formation of the magnetic attraction region and the non-magnetic attraction region on the sorting tube 68. By rotating the sorting tubes 68, the ferromagnetic material adhering to the sorting tube 68 can be moved to the non-magnetic attraction region. At this time, driven by its own gravity, the ferromagnetic material can fall into the designated collection region, completing the collection of the ferromagnetic material. When the ferromagnetic material is encapsulated by the carbon black, the ferromagnetic material encapsulated with the carbon black falls from the discharging end of the first guide plate 63 due to gravity into the crushing section 66. Then, the crushing motor 661 starts to operate. The operating crushing motor 661 drives the driving wheel to rotate. The transmission belt 662 drives the driven wheel 663 to rotate. The operating driven wheel 663 drives the driving shaft to operate, thereby driving the driven wheels 663 in other crushing members to rotate. The operating driven wheel 663 drives the first connecting rod 666 to operate. The operating first connecting rod 666 drives the second connecting rod 667 to operate. Then, the operating second connecting rod 667 causes the second crushing plate 665 to rotate about the rotating shaft 668, thereby crushing the carbon black passing between the first crushing plate 664 and the second crushing plate 665. This can crush the carbon black encapsulated on the ferromagnetic material, reducing the mass of the carbon black, allowing the permanent magnet 67 to attract the ferromagnetic material. Then, as the sorting tube 68 rotates, the sorting operation for the ferromagnetic material is performed.

Beneficial effects of the pyrolysis device provided by the embodiments of the present disclosure include, but are not limited to that: to sort and collect the ferromagnetic material, the pyrolysis device is provided with at least two sorting tubes, an adjustment section disposed in each of the at least two sorting tubes, and a plurality of permanent magnets disposed on the adjustment section. Therefore, during the sorting operation, by adjusting the locations of the permanent magnets in the second sorting tube, the distance between each permanent magnet in the second sorting tube and the inner wall of the second sorting tube is made smaller than the distance between each permanent magnet in the first sorting tube and the inner wall of the first sorting tube, thereby increasing its magnetic force. Consequently, when the mass of the ferromagnetic material falling into the crushing assembly is greater than a preset ferromagnetic material mass, since the orthographic projections of the first guide plate, the first sorting tube, and the second sorting tube have overlapping regions, the ferromagnetic material flowing out from the first guide plate or the ferromagnetic material falling off the first sorting tube due to its mass exceeding the preset mass will contact the second sorting tube. At this time, the permanent magnets in the second sorting tube can perform the attraction operation on the ferromagnetic material, completing the sorting of the ferromagnetic material. Simultaneously, to prevent the carbon black from adhering to the surface of the ferromagnetic material, thereby reducing the attraction force of the permanent magnet on the ferromagnetic material and preventing the ferromagnetic material from being discharged from the designated location, the pyrolysis device is also provided with a crushing section located at the discharging end of the first guide plate, which can perform secondary processing on the carbon black, and prevent the carbon black from encapsulating the ferromagnetic material, thereby completing the sorting operation of the ferromagnetic material.

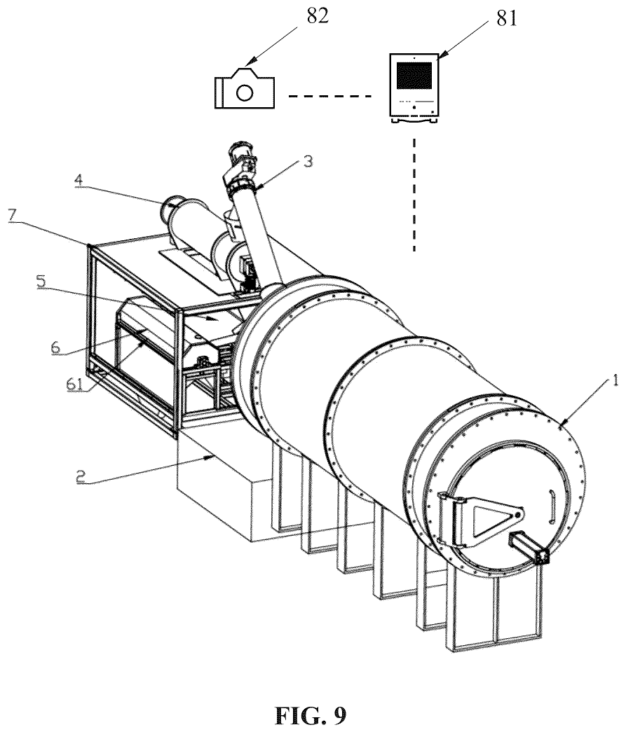

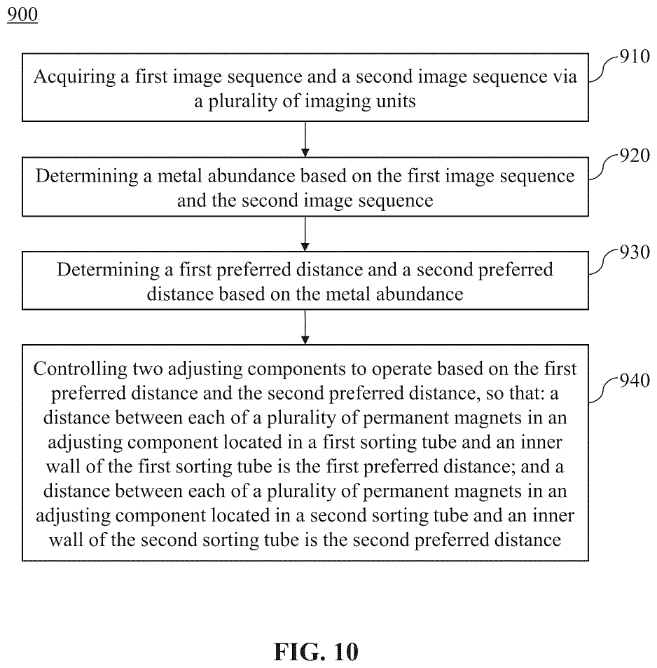

FIG. 9 is another schematic diagram of the pyrolysis device for the waste circuit board according to some embodiments of the present disclosure. FIG. 10 is a flowchart of a process for controlling an operation of an adjustment section according to some embodiments of the present disclosure.

In some embodiments, as shown in FIG. 9, the pyrolysis device further includes a processor 81 and a plurality of imaging units 82.

The processor 81 refers to a device or component configured to process data and generate instructions, e.g., a central processing unit (CPU), a graphics processing unit (GPU), an application-specific integrated circuit (ASIC), etc., or any combination thereof. The data may originate from the aforementioned different components or other data sources. The instructions may be sent to the aforementioned different components. The processor 81 may also include other components related to the aforementioned content, e.g., a computer, a mobile phone, a server, an industrial computer, a circuit board with a computing function, etc. In some embodiments, the processor 81 may be disposed on the support frame 7, or may be arranged at other feasible locations on the pyrolysis device. In some embodiments, the processor may be communicatively connected to the plurality of imaging units 82 and the other components mentioned above.

The imaging unit 82 refers to a unit configured to acquire relevant images inside the pyrolysis device. In some embodiments, the plurality of imaging units 82 may be respectively disposed above the carbon black collection tank and above the inclined plate. In some embodiments, the imaging units 82 disposed above the carbon black collection tank 2 may be configured to acquire a first image sequence, and the imaging units 82 disposed above the inclined plate 54 may be configured to acquire a second image sequence.

Merely by way of example, as shown in FIG. 10, the processor 81 may perform the following steps 910-940.

Step 910, acquiring the first image sequence and the second image sequence via the plurality of imaging units 82.

The first image sequence refers to a set of time-series images reflecting macroscopic characteristics of raw materials before entering a sorting system. In some embodiments, the first image sequence includes a plurality of images of a mixture in the carbon black collection tank.

The second image sequence refers to a set of time-series images reflecting the state of the materials after initial transferring and cooling, before entering the sorting tubes. In some embodiments, the second image sequence includes a plurality of images of a mixture on the inclined plate.

In some embodiments, the imaging units 82 may acquire the first image sequence and the second image sequence by shooting based on a preset interval. The preset interval refers to a preset duration between each shooting by the imaging units 82, e.g., the preset interval may be 0.1 s (i.e., 10 frames per second), 0.5 s (i.e., 2 frames per second), etc. In some embodiments, the preset intervals for the imaging units 82 disposed above the carbon black collection tank 2 and the imaging units 82 disposed above the inclined plate 54 may be the same or different, which may be specifically set by the processor 81 or an operator according to actual conditions.

Step 920, determining a metal abundance based on the first image sequence and the second image sequence.

The metal abundance refers to an indicator for quantifying the content of ferromagnetic metal in the mixture. For example, the metal abundance may be a percentage of ferromagnetic metal content per unit volume of the mixture.

In some embodiments, the processor 81 may determine the metal abundance based on the first image sequence and the second image sequence in various ways. For example, the processor 81 may utilize related technologies such as image preprocessing and characteristic segmentation to process the first image sequence and the second image sequence to determine the metal abundance. Exemplary steps are as follows.

1) Image preprocessing: performing geometric correction, illumination normalization, image enhancement, etc., on each frame of images in the first image sequence and the second image sequence.

2) Characteristic segmentation: using a multi-threshold segmentation algorithm (e.g., OTSU algorithm) or a pre-trained image segmentation neural network to divide pixels in the image into at least two categories: a metal region (manifested as high brightness, high contrast, or having metallic luster) and a non-metal region (i.e., the carbon black, manifested as low brightness or low contrast).

3) Metal abundance determination: calculating a ratio of a total pixel area of metal regions in all images to a total pixel area of all the images and mapping the ratio to the metal abundance according to a preset rule. Merely by way of example, the preset rule may be querying a first preset table. The first preset table includes a one-to-one mapping relationship between the ratio (or a range of the ratio) and the metal abundance. The first preset table may be constructed by a technician based on historical data or prior knowledge.

Step 930, determining a first preferred distance and a second preferred distance based on the metal abundance.

The first preferred distance refers to a preferred distance between each of the plurality of permanent magnets in the first sorting tube and the inner wall of the first sorting tube. The second preferred distance refers to a preferred distance between each of the plurality of permanent magnets in the second sorting tube and the inner wall of the second sorting tube.

In some embodiments, the processor 81 may determine the first preferred distance and the second preferred distance based on the metal abundance in a variety of ways. For example, the processor 81 may determine the first preferred distance and the second preferred distance by querying a second preset table based on the metal abundance. As another example, the processor 81 may determine the first preferred distance and the second preferred distance by substituting the metal abundance into an empirical model function. The second preset table or the empirical model function is built into the processor 81. The second preset table or the empirical model function includes a mapping relationship between the metal abundance and a combination of the first preferred distance and the second preferred distance. Merely by way of example, the second preset table or the empirical model function may be established in advance by a technician through offline experiments or historical data analysis. The second preset table or the empirical model function includes combinations of the first preferred distance and the second preferred distance corresponding to different metal abundances, which are verified as efficient by experience.

In some embodiments, more content for determining the first preferred distance and the second preferred distance is described in the related description below.

Step 940, controlling the two adjustment sections to operate based on the first preferred distance and the second preferred distance, so that: the distance between each of the plurality of permanent magnets 67 in the adjustment section 62 located in the first sorting tube and the inner wall of the first sorting tube is the first preferred distance; and the distance between each of the plurality of permanent magnets 67 in the adjustment section 62 located in the second sorting tube and the inner wall of the second sorting tube is the second preferred distance.

In some embodiments, the processor 81 may control the driving member in the adjustment section 62 in the first sorting tube based on the first preferred distance, to adjust locations of the plurality of permanent magnets 67 in the adjustment section 62, thereby adjusting the distances between the plurality of permanent magnets 67 and the inner wall of the sorting tube to be the first preferred distance. The processor 81 may control the driving member in the adjustment section 62 in the second sorting tube based on the second preferred distance, to adjust locations of the plurality of permanent magnets 67 in the adjustment section 62, until the distances between the plurality of permanent magnets 67 in the adjustment section 62 located in the second sorting tube and the inner wall of the second sorting tube is the second preferred distance.

In some embodiments of the present disclosure, by providing the processor 81 and the plurality of imaging units 82, the metal abundance is determined based on image data acquired by the imaging units 82, and then the first preferred distance and the second preferred distance are determined. The locations of the plurality of permanent magnets in the adjustment section in the corresponding sorting tube can be adjusted to achieve a better sorting effect.

In some embodiments, as shown in FIG. 7, the pyrolysis device further includes a plurality of vibration units 83.

The vibration unit 83 refers to a unit configured to turn over the mixture in the carbon black collection tank 2 or the inclined plate 54 through vibration. In some embodiments, the plurality of vibration units 83 are respectively disposed at a bottom of the carbon black collection tank 2 and a bottom of the inclined plate 54.

In some embodiments, the vibration unit 83 is configured to generate vibration. For example, the vibration unit 83 may uniformly transmit high-frequency (e.g., 30-60 Hz) micro-amplitude vibration energy to a tank body of the carbon black collection tank 2 and a plate body of the inclined plate 54, thereby turning over the mixture in the carbon black collection tank 2 or the inclined plate 54.

In some embodiments of the present disclosure, by providing the plurality of vibration units, representativeness and accuracy of images acquired by the imaging units can be improved. The specific frequency and amplitude of composite vibration generated by the vibration units can break static friction and cohesion between material particles, causing the entire material pile to exhibit a fluid-like state. In the fluid-like state, the lower-layer material is continuously turned over to a surface layer, and the surface-layer material settles down, forming a continuous, slow vertical mixing process, thereby better presenting the real situation of the materials.

In some embodiments, a shooting timing of the imaging units 82 controlled by the processor 81 may be synchronized with an operation cycle of the vibration units 83. For example, the processor 81 may control the imaging units 82 to perform shooting after a brief delay after the vibration units 83 are started, to ensure that the captured image can represent an average characteristic of the entire batch of materials, thereby significantly improving accuracy of the subsequently determined metal abundance.

In some embodiments, as shown in FIG. 5, the pyrolysis device further includes an acoustic sensing unit 84.

The acoustic sensing unit 84 refers to a unit configured to capture acoustic waves generated when the material collides and rubs against a related structure (e.g., the first crushing plate 664). In some embodiments, the acoustic sensing unit 84 may be disposed on a side wall of the first crushing plate 664 that does not physically contact the carbon black.

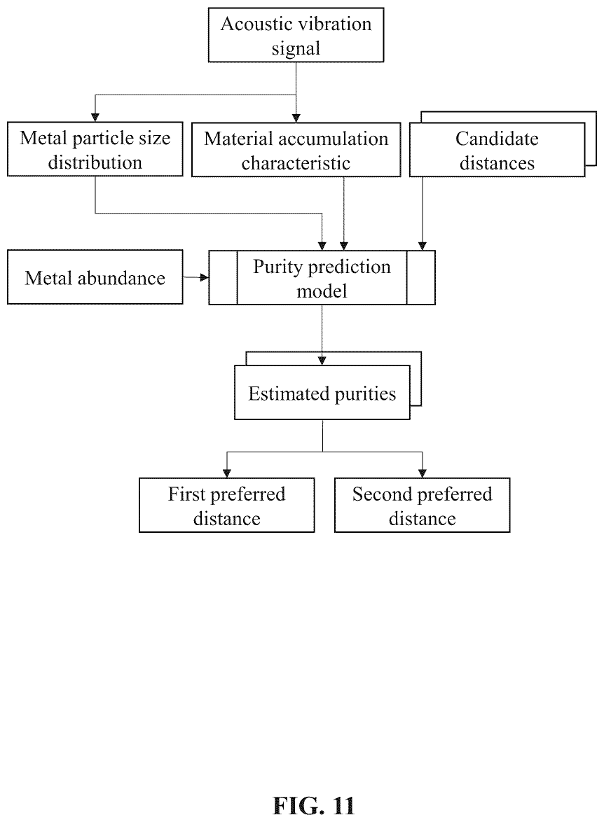

FIG. 11 is a schematic diagram of a purity prediction model according to some embodiments of the present disclosure.

In some embodiments, as shown in FIG. 11, the processor 81 is further configured to: acquire an acoustic vibration signal generated by a material flow passing through the crushing section via the acoustic sensing unit 84; determine a metal particle size distribution and a material accumulation characteristic ((also referred to as material flow characteristic) based on the acoustic vibration signal; generate a plurality of groups of candidate distances; determine estimated purities corresponding to the plurality of groups of candidate distances through the purity prediction model based on the metal abundance, the metal particle size distribution, the material accumulation characteristic, and the plurality of groups of candidate distances; and determine the first preferred distance and the second preferred distance from the plurality of groups of candidate distances based on the estimated purities corresponding to the plurality of groups of candidate distances.

The acoustic vibration signal refers to an acoustic wave signal generated when material particles collide and rub against a related structure. For example, the acoustic vibration signal may be a broadband structural vibration signal or an airborne acoustic wave signal.

In some embodiments, the processor 81 may acquire the acoustic vibration signal generated by the material flow passing through the crushing section 66 via the acoustic sensing unit 84.

The metal particle size distribution refers to data reflecting a distribution of particles of different particle sizes in the material.

The material accumulation characteristic refers to data reflecting a density or fluidity of material accumulation.

In some embodiments, the processor 81 may determine the metal particle size distribution and the material accumulation characteristic based on the acoustic vibration signal in a variety of ways. For example, the processor 81 may process and perform pattern recognition on the acquired acoustic vibration signal to acquire the metal particle size distribution and the material accumulation characteristic. Exemplary steps are as follows.

1) Signal processing: performing a Fourier transform or a wavelet transform on an original acoustic vibration signal (i.e., a time-domain signal) to convert the original acoustic vibration signal into a frequency-domain spectrum.

2) Metal particle size distribution determination: analyzing an energy distribution characteristic of the frequency-domain spectrum. Since collisions of large metal particles excite acoustic signals with high energy and low frequency, and collisions of small metal particles generate signals with low energy and high frequency, the processor 81 may estimate and determine a relative distribution proportion of metal in different particle size ranges in the material by determining an energy proportion of signals in different frequency bands (e.g., <1 kHz, 1-5 kHz, >5 kHz), thereby determining the metal particle size distribution. The particle size ranges may correspond to three preset particle size ranges (e.g., large, medium, and small), or may be more.

3) Material accumulation characteristic determination: analyzing a signal envelope and a duration of the original acoustic vibration signal (i.e., the time-domain signal). Since a material flow that is loose and has good fluidity generates discrete, pulse-like signals, and a material flow that is viscous and agglomerated generates signals with a long duration and smooth energy fluctuation, i.e., “friction sounds”, the processor 81 may calculate statistical characteristics such as kurtosis and duration of the acoustic vibration signal, and determine whether the material accumulation characteristic is “loose type”, “agglomerated type”, etc., by querying a third preset table. A technician may preset a plurality of material accumulation characteristics in advance, and correspond the plurality of material accumulation characteristics to the kurtosis and duration of the acoustic vibration signal to construct the third preset table.

In some embodiments, the processor 81 may generate the plurality of groups of candidate distances in a variety of ways. Each group of candidate distances includes a first candidate distance and a second candidate distance. For example, the processor 81 may generate a series of coordinate points (D1, D2) by systematically sampling in a preset two-dimensional space that satisfies constraints. Each coordinate point represents one group of candidate distances. The constraints include D1_min<=D1<=D1_max, D2_min<=D2<=D2_max, D1>D2, where D1 denotes the first candidate distance, and D2 denotes the second candidate distance. Merely by way of example, the sampling manner may include grid sampling, random sampling, or sampling based on a heuristic algorithm (e.g., “population initialization” in a genetic algorithm, generating a set of initial solutions).

The estimated purity refers to a predicted value of a final product purity value corresponding to a group of candidate distances.

The purity prediction model refers to a model used to determine the estimated purity corresponding to a group of candidate distances. In some embodiments, the purity prediction model may be a machine learning model. For example, the purity prediction model may be a Gradient Boosting Decision Tree (GBDT) or a Deep Neural Network (DNN) model. In some embodiments, an input of the purity prediction model may include a set of operating condition variables (i.e., the metal abundance, the metal particle size distribution, and the material accumulation characteristic) and a group of control variables (i.e., the candidate distances). An output of the purity prediction model may be the estimated purity corresponding to the set of operating condition variables and the group of control variables. This is equivalent to “virtually running” each candidate solution (corresponding to each group of candidate distances) inside the processor 81 and predicting a corresponding result.

In some embodiments, the processor 81 may acquire the purity prediction model by training based on a large number of training samples with training labels. The training samples may be sample operating condition variables and sample control variables from historical records. The training labels may be historical actual purity values of final products corresponding to the training samples. The training labels may be automatically annotated by the processor 81 according to the historical records.

In some embodiments, the processor 81 may perform a plurality of rounds of iteration. At least one round of iteration includes: inputting one or more training samples into an initial purity prediction model to acquire outputs corresponding to the one or more training samples; substituting the outputs of the initial purity prediction model and the actual training labels into a predefined loss function to calculate a value of the loss function; and iteratively updating the initial purity prediction model based on the loss function, for example, updating based on a gradient descent method. When the value of the loss function satisfies an iteration completion condition, the training is completed, and a trained purity prediction model is acquired. The iteration completion condition may include convergence of the loss function, the count of iterations reaching a threshold, etc.

In some embodiments, the processor 81 may determine the first preferred distance and the second preferred distance from the plurality of groups of candidate distances in various ways based on the estimated purities corresponding to the plurality of groups of candidate distances. For example, the processor 81 may evaluate all groups of candidate distances and corresponding estimated purities thereof, and select an optimal solution according to a preset decision criterion. Merely by way of example, the evaluation process and the decision criterion may include following steps.

1) Screening qualified solutions: eliminating all groups of candidate distances whose estimated purity is below a preset minimum purity threshold.

2) Finding an optimal energy consumption solution: among all groups of candidate distances whose estimated purities are above the minimum purity threshold, further substituting the groups into an energy consumption model: E=f_e (D1, D2), to acquire corresponding energy consumptions. The energy consumption model refers to a model reflecting the functional relationship between the candidate distances and the motor power of the driving motor 629. It can be understood that the energy consumption of the driving motor 629 mainly comes from driving the rotation of the sorting tube 68, and its load is mainly used to overcome the mechanical friction caused by the magnetic attraction force. Merely by way of example, the energy consumption model can be simplified and expressed as Equation (1):

$$E = \frac{C 1}{D {1}^{2}} + \frac{C 2}{D {2}^{2}} + {P}_{b a s e} \qquad ( 1 )$$

where E denotes energy consumption; D1 and D2 denote the first candidate distance and the second candidate distance, respectively; C1, C2 are inherent coefficients acquired through experimental calibration; P_{base} denotes base power consumption, which is an inherent parameter acquired via experimental calibration. It can be seen that: the smaller the candidate distances, the greater the attraction force of the plurality of permanent magnets, and the higher the corresponding friction and energy consumption. The energy consumption model can be used to quickly calculate and find the group with the lowest energy consumption.

3) Determining the final preferred distances: there may be various determination manners. For example, the group of candidate distances with the lowest energy consumption among all groups of candidate distances whose estimated purities are above the minimum purity threshold may be selected and used as the final first preferred distance and the final second preferred distance. As another example, the group of candidate distances with the highest estimated purity may be selected and used as the final first preferred distance and the final second preferred distance.

In some embodiments of the present disclosure, by arranging the acoustic sensing unit, collecting and processing the acoustic vibration signal, and combining the purity prediction model to assist in determining the first preferred distance and the second preferred distance, the actual operating conditions and historical data can be combined to more accurately estimate the purity value of the final product, thereby determining appropriate first and second preferred distances, laying a good foundation for subsequently adjusting the distances between the plurality of permanent magnets and the inner wall of the sorting tube.

In some embodiments, the processor 81 is further configured to: during a sorting period, determine a first sorting load and a second sorting load in real time; and update the first preferred distance and the second preferred distance based on the first sorting load and the second sorting load.

The sorting period refers to a period during which the material passes through the first sorting tube and the second sorting tube for sorting.

The first sorting load refers to a dynamic parameter that reflects in real time the total amount of the ferromagnetic material actually attracted on the inner wall of the first sorting tube. For example, the first sorting load may be a total mass or a total volume of the ferromagnetic material actually attracted on the inner wall of the first sorting tube in real time.

The second sorting load refers to a dynamic parameter that reflects in real time the total amount of the ferromagnetic material actually attracted on the inner wall of the second sorting tube. For example, the second sorting load may be a total mass or a total volume of the ferromagnetic material actually attracted on the inner wall of the second sorting tube in real time.

In some embodiments, one or more magnetic field sensors may be deployed on external fixed frames of the first sorting tube and the second sorting tube, respectively, along the circumference directions of the first sorting tube and the second sorting tube. For example, the magnetic field sensor may be a Hall sensor, a Micro-Electro-Mechanical System (MEMS) magnetic sensor, etc. In some embodiments, the processor 81 may be communicatively connected to the one or more magnetic field sensors.

In some embodiments, during the sorting period, the processor 81 monitors the magnetic field strength measured by the one or more magnetic field sensors in real time, and determines the first sorting load and the second sorting load based on the magnetic field strength measured in real time. For example, when the ferromagnetic material is attracted on the inner wall of the sorting tube, it causes a local magnetic field disturbance. The processor 81 may calculate a difference between the real-time magnetic field strength and a pre-stored no-load reference magnetic field strength, input the difference into a preset physical model (such as a preset physical formula or a preset table constructed based on historical experience), and acquire an output equivalent mass or volume of the attracted material, which is used as the first sorting load or the second sorting load determined in real time.

In some embodiments, the processor 81 may update the first preferred distance and the second preferred distance in various ways based on the first sorting load and the second sorting load. Merely by way of example, the steps for the processor 81 to update the first preferred distance and the second preferred distance based on the first sorting load and the second sorting load may be as follows.

1) Setting a load threshold: the processor 81 may have a built-in preferred load range, operating within this range can ensure a high purity and a high recovery rate of the final product. The preferred load range includes an upper limit threshold and a lower limit threshold of the load, which may be preset based on experience or may be related to the metal abundance. For example, the higher the metal abundance, the greater the upper limit threshold and the lower limit threshold.

2) Real-time comparison and decision: the processor 81 compares the first sorting load and the second sorting load determined in real time with the preferred load range.

3) Performing the update: if the first/second sorting load remains above the upper limit threshold (overload), it indicates that the current magnetic force is too strong and impurities are easily entrained. The processor 81 may increase the corresponding first/second preferred distance to weaken the magnetic force. If the first/second sorting load remains below the lower limit threshold (underload), it indicates that the magnetic force may be insufficient, posing a risk of material loss. The processor 81 may decrease the corresponding first/second preferred distance to enhance the magnetic force.

The above update process is performed in a high-frequency loop, forming a closed-loop feedback, enabling the sorting system to automatically resist operating condition fluctuations and always operate within the preferred load range.

In some embodiments of the present disclosure, by updating the first preferred distance and the second preferred distance according to the first sorting load and the second sorting load determined in real time, the locations of the plurality of permanent magnets can be fine-tuned in real time according to the operating conditions during the sorting period, so that the driving motor always operates within a relatively efficient load range, further optimizing the sorting process.

In some embodiments, as shown in FIG. 5, the pyrolysis device further includes an airflow blowing unit 85.

The airflow blowing unit 85 refers to a unit for blowing carbon black powder. In some embodiments, the airflow blowing unit 85 is arranged at a bottom of the first crushing plate 664, so as to remove the carbon black powder on the surface of ferromagnetic material when the ferromagnetic material is crushed and exposed. “When the ferromagnetic material is crushed and exposed” refers to a moment when the secondary crushing process is completed, the carbon black coating layer is broken, and a fresh metal surface is exposed. Blowing at this moment achieves the best effect, preventing the powder from adhering again. The processor 81 may control the airflow blowing unit 85 to ensure precise synchronization between the injection of the airflow and the timing of the material falling.

In some embodiments, the airflow blowing unit 85 may be a system consisting of a high-pressure air source (such as a variable-frequency centrifugal fan or a compressed air storage tank), a pipeline system, and at least one nozzle. The nozzle may be arranged at the bottom of the first crushing plate 664, i.e., on a critical path after the material undergoes secondary crushing and before falling into the sorting tube 68. The nozzle may be a Laval nozzle, a flat curtain nozzle, etc., aiming to generate a high-speed, focused airflow curtain covering the entire material falling cross-section. The high-speed airflow curtain exerts two effects on the falling material particles: impact stripping, where the airflow directly impacts the particle surface, “knocking” off large or loosely attached carbon black powder from the metal surface; and boundary layer shearing, where an extremely thin boundary layer with a very high velocity gradient is formed on the particle surface by the high-speed airflow, generating strong shear stress that can effectively “scrape off” fine dust tightly adhering to the metal surface.

In some embodiments, the processor 81 is configured to: acquire the acoustic vibration signal generated by the material flow passing through the crushing section via the acoustic sensing unit 84; determine the metal particle size distribution and the material accumulation characteristic based on the acoustic vibration signal; determine a first adjustment quantity based on the metal particle size distribution; determine a second adjustment quantity based on the material accumulation characteristic; determine an airflow parameter based on the first adjustment quantity and the second adjustment quantity; and control the airflow blowing unit 85 to operate with the airflow parameter. For descriptions regarding a process for acquiring the acoustic vibration signal and determining the metal particle size distribution and the material accumulation characteristic based on the acoustic vibration signal, refer to the related descriptions above.

The first adjustment quantity refers to data used for basic adjustment of the airflow intensity of the airflow blowing unit 85. The first adjustment quantity may be represented by a wind speed unit (m/s).

In some embodiments, the processor 81 may determine the first adjustment quantity in a plurality of ways based on the metal particle size distribution. For example, the processor 81 may first quantify the metal particle size distribution, and then invoke a reference function to determine the first adjustment quantity. The process may include the following steps.

1) Quantifying the metal particle size distribution: converting the metal particle size distribution into a single, quantified “average particle size index” (APSI). For example, the APSI may be calculated by performing a weighted average calculation on particle sizes in different size ranges, where the weights are proportional to the sizes of the particle size ranges.

2) Invoking the reference function: the processor 81 has a built-in reference function ΔS1=F_size (APSI), where ΔS1 denotes the first adjustment quantity. The reference function indicates a nonlinear mapping relationship (which can be implemented via a mapping table or a piecewise function). The logic of the mapping relationship is as follows: when the APSI is low (indicating a high proportion of small particles), ΔS1 is a relatively large negative value. This indicates that the base airflow intensity needs to be significantly reduced to prevent fine metal particles from being blown away along with the carbon black powder, which may cause a loss in recovery rate. When the APSI is high (indicating a high proportion of large particles), ΔS1 is a positive value or close to zero. This indicates that the airflow intensity can be maintained or moderately increased, because large particles have high inertia and are not easily blown away by the airflow, which can increase the kinetic energy to help strip the carbon black powder attached to their surfaces. The APSI calculated in real time is substituted into the aforementioned function, and the output is the first adjustment quantity. It represents a fundamental upward or downward adjustment to the airflow intensity in response to changes in the particle size of the material.

The second adjustment quantity refers to data used for performing an additional adjustment to the airflow intensity and airflow mode of the airflow blowing unit 85. In some embodiments, the second adjustment quantity may simultaneously include an intensity adjustment quantity and a mode parameter. The intensity adjustment quantity in the second adjustment quantity may be represented by a wind speed unit (m/s). The mode parameter in the second adjustment quantity may include a “continuous steady mode” and a “high-frequency pulse mode”. Technicians may also set more modes according to actual requirements.

In some embodiments, the processor 81 may determine the second adjustment quantity in a plurality of ways based on the material accumulation characteristic. For example, taking the case where the material accumulation characteristic is divided into two types: “loose type” and “agglomerated type”, when the material accumulation characteristic is the “loose type”, it indicates that the material has good fluidity and the powder is easy to strip. At this time, the intensity adjustment quantity in the second adjustment quantity is set to a small positive value or zero, indicating that only a fine adjustment is needed or no additional enhancement of the airflow intensity is required. Simultaneously, the mode parameter in the second adjustment quantity is set to the “continuous steady mode”. When the material accumulation characteristic is the “agglomerated type”, it indicates that the material is sticky and there are particle agglomerates encapsulated by the carbon black, requiring additional energy to break them up. At this time, the intensity adjustment quantity in the second adjustment quantity is set to a significant, relatively large positive value, indicating that the airflow intensity needs to be greatly enhanced. Simultaneously, the mode parameter in the second adjustment quantity is switched to the “high-frequency pulse mode”. In this mode, the airflow blowing unit 85 generates a series of short but powerful airflow pulses, which effectively break up the particle agglomerates through continuous impact, achieving deeper cleaning.

The airflow parameter refers to a relevant parameter during an operation of the airflow blowing unit 85. For example, the airflow parameter may include the airflow intensity and the airflow mode during the operation of the airflow blowing unit 85. The airflow intensity in the airflow parameter may be represented by a wind speed unit (m/s). The airflow mode in the airflow parameter is similar to the mode parameter in the second adjustment quantity, referring to the related description above.

In some embodiments, the processor 81 may determine the airflow parameter in a plurality of ways based on the first adjustment quantity and the second adjustment quantity. For example, the processor 81 may calculate a total adjustment value based on the first adjustment quantity and the intensity adjustment quantity in the second adjustment quantity to determine the airflow intensity in the airflow parameter, and determine the airflow mode in the airflow parameter according to the mode parameter included in the second adjustment quantity. Merely by way of example, the processor 81 may determine the airflow parameter according to the following steps.

1) Calculating a base intensity: calculating a fused total adjustment value. For example, the first adjustment quantity and the intensity adjustment quantity in the second adjustment quantity may be directly added, or the first adjustment quantity and the intensity adjustment quantity in the second adjustment quantity may be weighted averaged, where the weights may be preset by a technician. The acquired result is used as the total adjustment value.

2) Determining the airflow intensity: applying the fused total adjustment value to a preset reference airflow intensity (e.g., directly add the fused total adjustment value to the reference airflow intensity) to acquire the airflow intensity. Simultaneously, the processor 81 checks whether the airflow intensity is within the physical upper and lower limits allowed by the pyrolysis device, performs a limiting process, and acquires a final airflow intensity. For example, if the airflow intensity acquired from the preliminary calculation is less than the lower limit allowed by the pyrolysis device, then the lower limit is used as the final airflow intensity. If the airflow intensity acquired from the preliminary calculation is greater than the upper limit allowed by the pyrolysis device, then the upper limit is used as the final airflow intensity. If the airflow intensity acquired from the preliminary calculation is within the physical upper and lower limits allowed by the pyrolysis device, then the airflow intensity is directly used as the final airflow intensity.

3) Determining the airflow mode: determining the mode parameter included in the second adjustment quantity as the airflow mode in the airflow parameter.

In some embodiments, the processor 81 may control the airflow blowing unit 85 to operate with the airflow parameter in a plurality of ways. For example, the processor 81 may convert the airflow intensity and the airflow mode into specific control signals. Merely by way of example, for the airflow intensity, the processor 81 may convert the airflow intensity into a 0-10V analog voltage signal or a pulse width modulation (PWM) signal, and send the 0-10V analog voltage signal or the PWM signal to a variable frequency fan or a proportional valve to control the speed or opening thereof, thereby precisely setting the flow rate and speed of the airflow. For the airflow mode, the processor 81 may control the on/off frequency of a high-speed solenoid valve according to the corresponding airflow mode to achieve the generation of pulsed airflow by the airflow blowing unit 85.

In some embodiments of the present disclosure, by using the first adjustment quantity and the second adjustment quantity determined based on the metal particle size distribution and the material accumulation characteristic, respectively, to determine the airflow parameter, thereby controlling the operation of the airflow blowing unit, the sweeping effect of the airflow blowing unit on the carbon black powder can be improved, and the efficiency and purity of metal recovery can be enhanced.

By providing the airflow blowing unit and utilizing the kinetic energy and the shear force of the high-speed airflow to actively overcome the adhesion force (including electrostatic force and van der Waals force) between the powder and the metal surface, a non-contact “dry cleaning” effect can be achieved. The blown-off, extremely light carbon black powder becomes suspended and is carried away due to the airflow action (a dust collection pipe may be provided for collection), while the much denser metal particles are substantially unaffected by the airflow trajectory and continue to fall along the original path. This allows the material to undergo a preliminary separation based on aerodynamics before entering the sorting process, greatly reducing the burden of the subsequent sorting process.

The preferred embodiments of the present disclosure have been described in detail above in connection with the accompanying drawings. However, the present disclosure is not limited to the specific details in the aforementioned embodiments. Within the scope of the technical concept of the present disclosure, various equivalent modifications can be made to the technical solutions of the present disclosure, and these equivalent modifications all fall within the protection scope of the present disclosure.

Each patent, patent application, patent application publication, and other material, such as articles, books, specifications, publications, documents, or the like, cited in the present disclosure is hereby incorporated by reference in its entirety. Except for any application history documents that are inconsistent or in conflict with the content of the present disclosure, and also except for any documents that limit the broadest scope of the claims of the present disclosure (whether currently or subsequently appended to the present disclosure). It should be noted that, if the description, definition, and/or use of terminology in any ancillary material of the present disclosure is inconsistent or in conflict with that described in the present disclosure, the description, definition, and/or use of terminology in the present disclosure shall prevail.

What is claimed is:

1. A pyrolysis device for a waste circuit board, comprising:
a pyrolysis furnace configured to perform pyrolysis treatment on the waste circuit board;
a carbon black collection tank configured to collect carbon black formed after the pyrolysis treatment of the waste circuit board;
a processing unit configured to crush the carbon black and separate magnetic metal from the carbon black;
a helical conveyor, wherein a feeding end of the helical conveyor is located in the carbon black collection tank, a discharging end of the helical conveyor is connected to the processing unit, and the helical conveyor is configured to transfer the carbon black to the processing unit;
wherein the processing unit includes a crushing assembly, and the crushing assembly includes a housing, two sorting tubes rotatably connected to the housing, a first guide plate disposed on the housing, two adjustment sections respectively provided in the two sorting tubes and connected to the housing, and a plurality of permanent magnets connected to each of the two adjustment sections;
each of the two adjustment sections is configured to adjust a distance between each of the plurality of permanent magnets and an inner wall of a corresponding sorting tube in the two sorting tubes, so that the plurality of permanent magnets attract the magnetic metal in the carbon black;
each of the two adjustment sections includes a connection shaft disposed on the housing, a first connecting sleeve and a second connecting sleeve sleeved on the connection shaft, and a driving member disposed on the second connecting sleeve;
the driving member includes a plurality of mounting seats disposed on the second connecting sleeve, a plurality of adjustment shafts disposed on the plurality of mounting seats, respectively, a plurality of adjustment gears sleeved on the plurality of adjustment shafts, respectively, universal joints for connecting adjacent adjustment shafts, and a plurality of adjustment racks meshing with the plurality of adjustment gears, respectively;
one of the universal joints is replaceable with a driving motor;
both the first connecting sleeve and the second connecting sleeve are provided with a plurality of grooves configured to place the plurality of adjustment racks, respectively, an inner wall of each of the plurality of grooves is provided with a limiting groove, and a protrusion adapted to the limiting groove is provided along a length direction of each of the plurality of adjustment racks;
the two sorting tubes are divided into a first sorting tube and a second sorting tube according to a moving sequence of the carbon black in the processing unit, wherein a rotation direction of the first sorting tube is opposite to a rotation direction of the second sorting tube, and the first sorting tube rotates in a counterclockwise direction;
the housing is further provided with a second guide plate and a third guide plate, and a first preset distance exists between each of the second guide plate and the third guide plate and an outer wall of the second sorting tube;
in an orthographic projection direction, a second preset distance exists between an axis of the first sorting tube and an axis of the second sorting tube, so that the carbon black sorted by the first sorting tube falls onto the second sorting tube;
a distance between each of a plurality of permanent magnets in an adjustment section located in the first sorting tube and an inner wall of the first sorting tube is greater than a distance between each of a plurality of permanent magnets in an adjustment section located in the second sorting tube and an inner wall of the second sorting tube; each adjustment section further includes a plurality of connecting rods for connecting the first connecting sleeve and the second connecting sleeve;
the plurality of connecting rods sequentially connect the plurality of permanent magnets located on a corresponding sorting tube to form a C-shaped structure, a diameter of the C-shaped structure is greater than an outer diameter of the second connecting sleeve and less than an inner diameter of the corresponding sorting tube;
the driving member is connected to the plurality of permanent magnets, configured to change locations of the plurality of permanent magnets in the corresponding sorting tube and enable the plurality of permanent magnets to perform synchronous movement, so as to adjust the distance between each of the plurality of permanent magnets and the inner wall of the corresponding sorting tube; and
the distance between each of the plurality of permanent magnets located in the first sorting tube and the inner wall of the first sorting tube is different from the distance between each of the plurality of permanent magnets in the adjustment section located in the second sorting tube and the inner wall of the second sorting tube.

2. The pyrolysis device according to claim 1, wherein the processing unit further includes a crushing section, the crushing section includes a first crushing plate and a plurality of fixed seats disposed in the housing, a plurality of crushing members disposed on the plurality of fixed seats, a driving shaft for connecting the plurality of crushing members, and a driving mechanism connected to one of the plurality of crushing members;
each of the plurality of crushing members includes a driven wheel rotatably connected to a corresponding fixed seat, a first connecting rod connected to the driven wheel, a second connecting rod movably connected to the first connecting rod, and a second crushing plate movably connected to the second connecting rod;
the second crushing plate is movably connected to the corresponding fixed seat via a rotating shaft;
the driving mechanism includes a crushing motor connected to the housing, a driving wheel disposed at an output end of the crushing motor, and a transmission belt for connecting the driving wheel and the driven wheel; and
a region between the first crushing plate and the second crushing plate is a crushing region for the carbon black.

3. The pyrolysis device according to claim 2, wherein the processing unit further includes a support frame, a cooling assembly disposed on the support frame and connected to the helical conveyor, a transfer assembly connected to a discharging end of the cooling assembly, and at least two hoppers connected to the crushing assembly; the transfer assembly is configured to transfer the carbon black to the crushing assembly.

4. The pyrolysis device according to claim 3, wherein the cooling assembly includes a cooling box fixedly disposed on the support frame, a feeding pipe provided in the cooling box, a helical mandrel located in the feeding pipe, a helical blade disposed on the helical mandrel, a feeding motor connected to one end of the helical mandrel and located outside a shell of the cooling box, and the at least two hoppers provided in the cooling box;
one end of the at least two hoppers is connected to the discharging end of the helical conveyor, and the other end is in communication with the feeding pipe; and
a carbon black distribution plate is disposed at a discharging end of the feeding pipe.

5. The pyrolysis device according to claim 4, wherein the cooling box is provided with a first partition plate, a second partition plate, a water inlet pipe, and a water outlet pipe; in a flow direction of a cooling liquid in the cooling box, the first partition plate and the second partition plate divide the cooling box into a first cooling zone, a second cooling zone, and a third cooling zone; the cooling box further includes a first connecting pipe and a second connecting pipe disposed in the second cooling zone for communicating the first cooling zone and the third cooling zone, and a communication pipe disposed on the second partition plate and located in the first cooling zone;
a distance between the first connecting pipe and the feeding pipe is greater than a distance between the second connecting pipe and the feeding pipe;
a water inlet end of the second connecting pipe is located in an overlapping region of the communication pipe and the second partition plate; and
the at least two hoppers are located in the third cooling zone, the communication pipe is in communication with the water inlet pipe, and the water outlet pipe is in communication with the first cooling zone.

6. The pyrolysis device according to claim 5, wherein the transfer assembly includes a mounting frame disposed on the support frame, an adjustment mechanism disposed on the mounting frame, a connecting frame connected to the adjustment mechanism, and an inclined plate disposed on the connecting frame and forming a preset angle with a height direction of the connecting frame;
the inclined plate is configured to receive the carbon black falling from the carbon black distribution plate;
the adjustment mechanism includes a transmission member disposed on the mounting frame, two transmission blocks connected to the transmission member, a moving frame connected to the two transmission blocks, a slider disposed on the moving frame, and a sliding rail disposed on the mounting frame and slidably connected to the slider; and
the connecting frame is connected to the moving frame.

7. The pyrolysis device according to claim 6, wherein the transmission member includes three supporting seats disposed on the mounting frame, two transmission screw rods for connecting adjacent supporting seats, and an adjustment motor disposed on the mounting frame and connected to one of the two transmission screw rods;
adjacent ends of the two transmission screw rods are respectively provided with a driving gear and a driven gear, and the driving gear meshes with the driven gear; and
the two transmission blocks are respectively sleeved on the two transmission screw rods.

8. The pyrolysis device according to claim 6, further comprising a processor and a plurality of imaging units, wherein the plurality of imaging units are respectively disposed above the carbon black collection tank and above the inclined plate, and the processor is configured to:
acquire a first image sequence and a second image sequence via the plurality of imaging units, wherein the first image sequence includes a plurality of images of a mixture in the carbon black collection tank, and the second image sequence includes a plurality of images of a mixture on the inclined plate;
determine a metal abundance based on the first image sequence and the second image sequence;
determine a first preferred distance and a second preferred distance based on the metal abundance; and
control the two adjustment sections to operate based on the first preferred distance and the second preferred distance, so that:
the distance between each of the plurality of permanent magnets in the adjustment section located in the first sorting tube and the inner wall of the first sorting tube is the first preferred distance; and
the distance between each of the plurality of permanent magnets in the adjustment section located in the second sorting tube and the inner wall of the second sorting tube is the second preferred distance.

9. The pyrolysis device according to claim 8, further comprising a plurality of vibration units, wherein the plurality of vibration units are respectively disposed at a bottom of the carbon black collection tank and a bottom of the inclined plate, and the plurality of vibration units are configured to generate vibration.

10. The pyrolysis device according to claim 8, further comprising an acoustic sensing unit, wherein the acoustic sensing unit is disposed on a side wall of the first crushing plate that does not physically contact the carbon black, and the processor is further configured to:
acquire an acoustic vibration signal generated by a material flow passing through the crushing section through the acoustic sensing unit;
determine a metal particle size distribution and a material accumulation characteristic based on the acoustic vibration signal;
generate a plurality of groups of candidate distances, each group of candidate distances including a first candidate distance and a second candidate distance;
determine estimated purities corresponding to the plurality of groups of candidate distances via a purity prediction model based on the metal abundance, the metal particle size distribution, the material accumulation characteristic, and the plurality of groups of candidate distances, wherein the purity prediction model is a machine learning model; and
determine the first preferred distance and the second preferred distance from the plurality of groups of candidate distances based on the estimated purities corresponding to the plurality of groups of candidate distances.

11. The pyrolysis device according to claim 8, wherein the processor is further configured to:
during a sorting period, determine a first sorting load and a second sorting load in real time; and
update the first preferred distance and the second preferred distance based on the first sorting load and the second sorting load.

12. The pyrolysis device according to claim 2, further comprising an airflow blowing unit, wherein the airflow blowing unit is disposed at a bottom of the first crushing plate.

13. The pyrolysis device according to claim 12, further comprising a processor and an acoustic sensing unit, wherein the acoustic sensing unit is disposed on a side wall of the first crushing plate that does not physically contact the carbon black, and the processor is configured to:
acquire, via the acoustic sensing unit, an acoustic vibration signal generated by a material flow passing through the crushing section;
determine a metal particle size distribution and a material accumulation characteristic based on the acoustic vibration signal;
determine a first adjustment quantity based on the metal particle size distribution;
determine a second adjustment quantity based on the material accumulation characteristic;
determine an airflow parameter based on the first adjustment quantity and the second adjustment quantity; and
control the airflow blowing unit to operate with the airflow parameter.
